(19) United States
(12) Patent Application Publication
(10) Pub. No.: US 2017/0091769 A1
(43) Pub. Date: Mar. 30, 2017

(54) DEVICE FOR FACILITATING IDENTIFICATION OF A FRAUDULENT PAYMENT CARD

(71) Applicant: MasterCard Asia/Pacific Pte. Ltd., Singapore (SG)

(72) Inventors: Barry WONG Hak Keung, Taipei City (TW); Chu Pen Chung, Hong Kong (HK)

(21) Appl. No.: 15/252,504

(22) Filed: Aug. 31, 2016

(30) Foreign Application Priority Data
Sep. 28, 2015 (SG) 10201508034P

(51) Int. Cl. G06Q 20/40; G06Q 20/32; G06Q 20/34; G06K 7/10

(52) U.S. Cl. CPC G06Q 20/409; G06K 7/10009; G06Q 20/3278; G06Q 20/341

(57) ABSTRACT

A device for facilitating identification of a fraudulent payment card, comprising: an input module for obtaining data encoded on a suspected fraudulent payment card; a volatile memory module for temporary storage of the obtained data; and a display module for rendering the obtained data on a display screen, wherein the obtained data that is stored in the volatile memory module is cleared after completion of an event.

### CROSS REFERENCE TO RELATED APPLICATION

This application is a U.S. National Stage filing under 35 U.S.C. §119, based on and claiming benefit of and priority to SG 10201508034P filed Sep. 28, 2015.

### TECHNICAL FIELD

The present disclosure relates broadly, but not exclusively, to a device for facilitating identification of a fraudulent payment card.

### BACKGROUND

Payment card fraud is prevalent in many countries and law enforcement personnel are constantly seeking ways to facilitate investigation and identification of payment card fraud.

Currently, when law enforcement personnel seize or recover a payment card, there may be a need to promptly determine whether or not the payment card is genuine or counterfeit. If the information encoded on the payment card (e.g. a magnetic stripe on the card) does not match the information indicated on the physical payment card, it is a good indication that the payment card is counterfeit.

Sometimes, criminals may “skim” payment card information from a genuine payment card and record this information on a card that is not a payment card (e.g. a hotel key card) or a dummy payment card. The hotel key card or dummy payment card can be used to conduct fraudulent purchases or withdraw money from an automatic teller machine (ATM).

To facilitate investigation and identification of payment card fraud, law enforcement personnel may wish to know certain information (e.g. cardholder's name, issuer of the payment card, card brand, card number and transaction history).

In the past, law enforcement personnel would approach a payment network (e.g. MasterCard®) to obtain the information. However, in recent times, data privacy laws and data security concerns have meant that the payment network may no longer be permitted to divulge such sensitive information. Even if the payment network is able to release less sensitive information (e.g. issuer of the payment card), administrative time is required to obtain such information. Unfortunately, in many instances, law enforcement personnel may require the necessary information urgently.

A need therefore exists to provide a device for facilitating identification of a fraudulent payment card that seeks to address at least the above-mentioned problems.

### SUMMARY

According to an aspect, there is provided a device for facilitating identification of a fraudulent payment card, comprising: an input module for obtaining data encoded on a suspected fraudulent payment card; a volatile memory module for temporary storage of the obtained data; and a display module for rendering the obtained data on a display screen, wherein the obtained data that is stored in the volatile memory module is cleared after completion of an event.

The event may comprise obtaining, by the input module, data encoded on a subsequent suspected fraudulent payment card.

The event may comprise obtaining, by the input module, data encoded on a pre-determined quantity of suspected fraudulent payment cards.

The event may comprise expiry of a pre-determined period of time.

The data may comprise at least one of: primary account number (PAN), expiration date, service code, and cardholder name.

The device may further comprise an authentication module for authenticating a user of the device based on credentials received by the authentication module to allow usage of the device.

The device may further comprise a processor module; and a non-volatile memory module for persistent storage of a plurality of Bank Identification Number (BIN) ranges and a payment network corresponding to each range, wherein the processor module is configured to: (i) determine the BIN range based on the obtained data, and (ii) retrieve the payment network corresponding to the determined BIN range. The display module may be further configured for rendering the retrieved payment network on the display screen.

The device may further comprise a processor module; and a non-volatile memory module for persistent storage of a plurality of Bank Identification Numbers (BINs) and an issuer identity corresponding to each BIN, wherein the processor module is configured to: (i) determine the BIN based on the obtained data, and (ii) retrieve the issuer identity corresponding to the determined BIN. The display module may be further configured for rendering the retrieved issuer identity on the display screen.

The device may further comprise a processor module; and a non-volatile memory module for persistent storage of a plurality of Bank Identification Numbers (BINs) and an issuer identity corresponding to each BIN, wherein the input module is configured for receiving a primary account number (PAN) provided by a user, and wherein the processor module is configured to: (i) determine the BIN based on the obtained PAN, and (ii) retrieve the issuer identity corresponding to the determined BIN.

The input module may comprise a magnetic stripe reader for obtaining data encoded on a magnetic stripe on the suspected fraudulent payment card. The input module may also comprise an integrated circuit (IC) reader for obtaining data encoded on an IC on the suspected fraudulent payment card. The input module may also comprise a Near Field Communication (NFC) reader for obtaining data encoded on a NFC tag on the suspected fraudulent payment card. The input module may also comprise a Radio-frequency Identification (RFID) reader for obtaining data encoded on a RFID tag on the suspected fraudulent payment card.

The device may further comprise a printer for printing the obtained data on a medium. The event may comprise printing of the obtained data on the medium.

### BRIEF DESCRIPTION OF THE DRAWINGS

Embodiments will be better understood and readily apparent to one of ordinary skill in the art from the following written description, by way of example only, and in conjunction with the drawings, in which:

FIG. 1 shows a schematic of a device for facilitating identification of a fraudulent payment card according to an embodiment.

Table 1 shows some example BIN ranges and their corresponding payment networks.

FIG. 2 shows a sample printout of a card forensic report according to an embodiment.

FIGS. 3A to 3I show flow charts illustrating exemplary process flows associated with operations according to various embodiments.

FIGS. 4A to 4K specify functional requirements associated with operations according to various embodiments.

FIGS. 5A to 5ZB show exemplary outputs on a display screen according to various embodiments.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

The present disclosure relates to devices for facilitating identification of a fraudulent payment card. Currently, many merchants accept electronic payment transactions as an alternative to cash for the payment for products. In such electronic payment transactions, a payment card may be used. As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Payment cards are typically uniquely tied to a consumer or card holder account. Typically, in a “card-present” electronic payment transaction, when a payment cardholder (consumer) wishes to purchase a product from a merchant, the payment cardholder presents his/her payment card to the merchant. The merchant typically has a point-of-sale (POS) terminal with a card reader that can interact/communicate with the payment card and facilitates the conduct of the electronic payment transaction.

The merchant typically submits a request to an acquirer (a financial institution that processes and settles the merchant's transactions with the help of an issuer). The acquirer then sends the request to the issuer (a financial institution, bank, credit union or company that issues or helps issue cards to payment card holders) to authorize the transaction. A financial institution/payment network (e.g. MasterCard®) acts as an intermediary between the acquirer and the issuer. If the acquirer authorizes the transaction (e.g. there are sufficient funds/credit in the payment card holder's account), the merchant releases the product to the payment card holder.

In the following description, the term “fraudulent payment card” or “suspected fraudulent payment card” is used. For the avoidance of doubt, the embodiments described herein are not exclusively/specifically used for identifying a (suspected) fraudulent payment card. In other words, the embodiments described herein are also applicable to “genuine” payment cards. However, since the context of the present disclosure relates broadly to devices for facilitating identification of a fraudulent payment card, the terms “fraudulent payment card” and “suspected fraudulent payment card” are used.

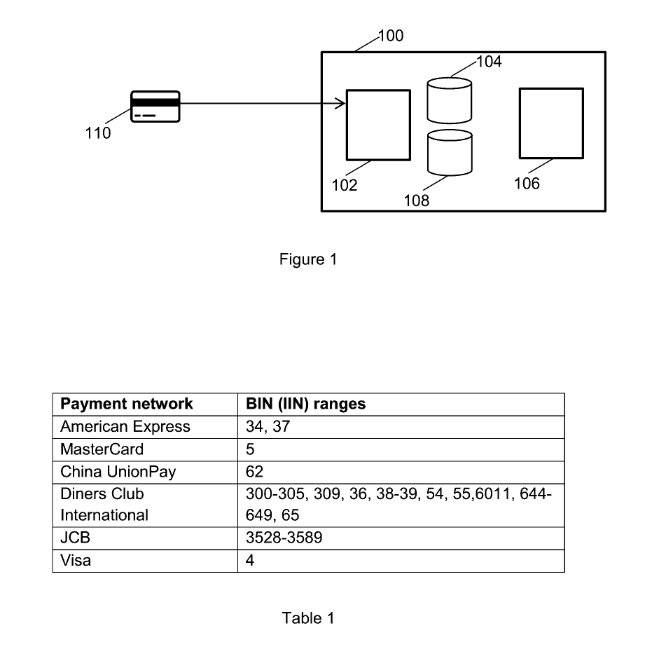

FIG. 1 shows a schematic of a device 100 for facilitating identification of a fraudulent payment card according to an embodiment. The device 100 comprises an input module 102 for obtaining data encoded on a suspected fraudulent payment card 110, a volatile memory module 104 for temporary storage of the obtained data, and a display module 106 for rendering the obtained data on a display screen (not shown in FIG. 1). The obtained data that is stored in the volatile memory module 104 is cleared or overwritten after completion/occurrence of an event. The obtained data that is stored in the volatile memory module 104 is also lost when power to the device 100 is interrupted or lost.

The data encoded on the suspected fraudulent payment card 110 may comprise at least one of: primary account number (PAN), expiration date, service code, and cardholder name. The PAN refers to the entire string of numbers of an account and its associated payment card. The leading digits (usually the first six) of the PAN are referred to as the Bank Identification Number (BIN). The service code determine where and how the payment card can be used (e.g. as an ATM card only, domestic use only, international use, etc.).

A user can manually input a PAN to retrieve relevant information. In this context, the PAN is considered to be encoded on a suspected fraudulent payment card 110 by virtue of the PAN being printed or embossed on the card surface. In such an implementation, the input module 102 is configured to read the inputted PAN. More information on this manual input option will be provided later.

As mentioned, the obtained data that is stored in the volatile memory module 104 is cleared or overwritten after completion/occurrence of an event. The event may be the successful completion/execution of an operation. In an implementation, the event may comprise obtaining, by the input module 102, data encoded on a subsequent suspected fraudulent payment card. That is, every time a new read operation is carried out, data from the previous read operation is erased.

Alternatively, data from more than one read operation may be temporarily stored in the volatile memory module 104. After a pre-determined number of read operations (e.g. 500) are performed, the stored data can be erased. Accordingly, in an implementation, the event comprises obtaining, by the input module 102, data encoded on a pre-determined quantity of suspected fraudulent payment cards.

Additionally or alternatively, the event may comprise expiry of a pre-determined period of time. That is, after a pre-determined timeout period (e.g. 10 minutes), data that is stored in the volatile memory module 104 is erased. More examples of events are provided below.

The device 100 may further comprise an authentication module (not shown in FIG. 1) for authenticating a user of the device 100 based on credentials received/obtained by the authentication module. If the user provides the correct credentials (e.g. password or personal identification number (PIN)), the user is granted usage of the device 100.

The temporary storage of the obtained data (i.e. the obtained data stored in the volatile memory module is cleared or overwritten after completion/occurrence of an event) and the implementation of the authentication module advantageously minimize abuse of the obtained data. As the device 100 is capable of extracting sensitive payment card information that is only meant for authorized personnel (e.g. law enforcement personnel investigating a payment card fraud case), the authentication module only allows authorized personnel to use the device. In addition, the obtained data is not persistently stored in the device so that subsequent users of the device 100 are not able to view previously obtained data.

In an implementation, the device 100 may further comprise a processor module (not shown in FIG. 1) and a non-volatile memory module 108 for persistent storage of a plurality of Bank Identification Number (BIN) ranges and a payment network corresponding to each range. Table 1 shows some BIN ranges and their corresponding payment networks. As mentioned above, the leading digits (usually the first six) of the PAN are referred to as the Bank Identification Number (BIN). A BIN may also be known as Issuer Identification Number (IIN). The BIN range consists of the first or first few numbers of the BIN. The processor module may be configured to: (i) determine the BIN range based on the obtained data, and (ii) retrieve the payment network corresponding to the determined BIN range. The BIN range may be determined based on the obtained PAN. The display module 106 may be further configured for rendering the retrieved payment network on the display screen.

In an implementation, the non-volatile memory module 108 (or another non-volatile memory module) may be used for persistent storage of a plurality of Bank Identification Numbers (BINs) and an issuer identity corresponding to each BIN. The processor module may be configured to: (i) determine the BIN based on the obtained data, and (ii) retrieve the issuer identity corresponding to the determined BIN. The BIN may be determined based on the obtained PAN. The display module 106 may be further configured for rendering the retrieved issuer identity on the display screen.

As mentioned above, a user may manually input a PAN. That is, a PAN is known (but the user may not have the physical payment card) and the user wishes to find out some other data associated with the PAN. The PAN is considered to be encoded on a suspected fraudulent payment card 110 by virtue of the PAN being printed or embossed on the card surface. In such an implementation, the device 100 comprises a processor module and a non-volatile memory module (e.g. non-volatile memory module 108 or a different non-volatile memory module) for persistent storage of a plurality of Bank Identification Numbers (BINs) and an issuer identity corresponding to each BIN. The input module 102 is configured for receiving/obtaining a primary account number (PAN) provided by the user, and the processor module is configured to: (i) determine the BIN based on the obtained PAN, and (ii) retrieve the issuer identity corresponding to the determined BIN.

The payment card 110 may come in various forms, such a card with a flexible body. Typically, the flexible body is sized according to a standard, for example, standards promulgated by the International Organization for Standardization (ISO) and the International Electrotechnical Commission (IEC). More specifically, ISO/IEC 7810:2003 ID-1 specifies a size for payment cards of 85.60 mm by 53.98 mm. Additionally, ISO/IEC 7813 specifies that an ID-1 compliant payment card have a thickness of 0.76 mm and corners rounded with a radius of 3.18 mm. The payment card may have a magnetic stripe or an integrated circuit (IC). The magnetic stripe is usually on the back of the payment card and has data stored/encoded therein. The magnetic stripe is usually broken up horizontally into three tracks, the first two tracks often contain duplicate data and most times the third track does not contain any data. ISO/IEC 7813 specifies the attributes of the stored/encoded data.

A payment card with an IC (also known as a smart card, chip card or IC card) may be based on the EMV technical standard. Such cards store their data on integrated circuits rather than magnetic stripes. They can be contact cards which must be physically inserted (or “dipped”) into a reader, or contactless cards which can be read over a short distance using radio-frequency (RF) identification technology (i.e. “tapped” on the reader).

Accordingly, the input module 102 may comprise a magnetic stripe reader for obtaining data encoded on a magnetic stripe on the suspected fraudulent payment card 110. The input module 102 may additionally or alternatively comprise an integrated circuit (IC) reader for obtaining data encoded on an IC on the suspected fraudulent payment card 110. The IC reader may be a contact card reader or contactless card reader. For contactless card readers, the input module 102 may comprise a Near Field Communication (NFC) reader for obtaining data encoded on a NFC tag on the suspected fraudulent payment card 110; or a Radio-frequency Identification (RFID) reader for obtaining data encoded on a RFID tag on the suspected fraudulent payment card 110.

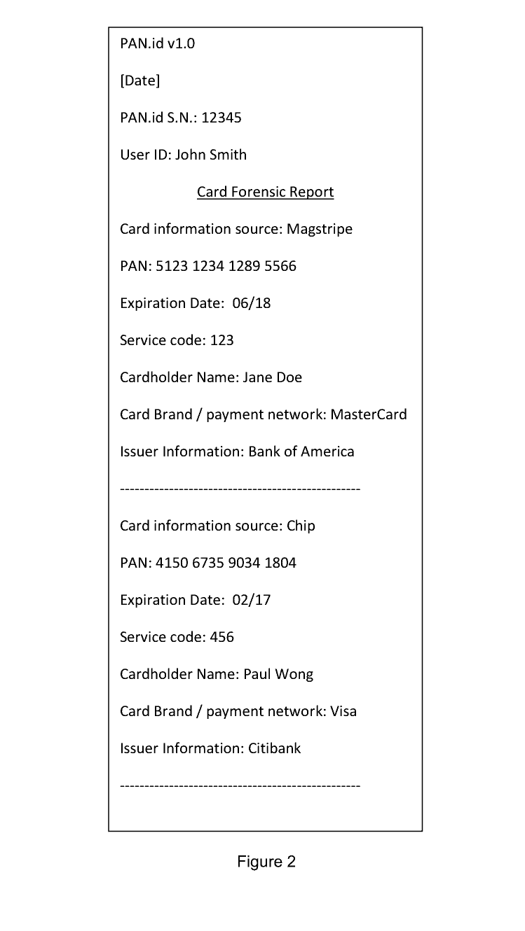

The device 100 may further comprise a printer (not shown in FIG. 1) for printing the obtained data on a medium (e.g. paper). FIG. 2 shows a sample printout of a card forensic report according to an embodiment. The card forensic report includes relevant information such as the encoded data (primary account number (PAN), expiration date, service code, and cardholder name) and retrieved data (payment network and issuer identity). In this case, the event may comprise printing of data on the medium. That is, after the obtained data and/or retrieved data is printed out, the data stored in the volatile memory module 104 is erased.

The device 100 is preferably portable and battery-operated and is a “stand-alone” device in the sense that it does not need to be connected to a central server/database in order to provide the user with the relevant information.

The device 100 may optionally comprises a keypad (e.g. for a user to input his credentials or a PAN) and suitable communication hardware for enabling communication with a payment card (e.g. a RF processor, a baseband processor and an antenna). The keypad may have several numbers (e.g. numbers “0” to “9”) and several command keys (e.g. “F1”, “F2”, “F3”, “F4”, “OK”, “X”).

The keypad and/or display screen may be controlled by an application processor. A power controller may be provided to supply power to the various hardware components.

Besides the volatile memory module 104 and non-volatile memory (NVM) module 108, other various different types of memory may be provided. For example, the device 100 may include Random Access Memory (RAM) connected to the application processor into which data and program code can be written and read from at will. Code placed anywhere in RAM can be executed by the application processor. The device 100 may also be provided with a long-term (persistent) storage connected to the application processor. The long-term storage may comprise three partitions, an operating system (OS) partition, a system partition and a user partition. The user partition may be used to realize the non-volatile memory module 108.

The device 100 may also include at least one communication interface. The communication interface allows software and data to be transferred between the device 100 and external devices via a communication path. The communication interface may permit data to be transferred between the device 100 and a data communication network, such as a public data or private data communication network. The communication interface may also be used to exchange data between external computing devices. Examples of a communication interface include a modem, a network interface (such as an Ethernet card), a communication port (such as a serial, parallel, printer, GPIB, IEEE 1394, RJ45, USB), an antenna with associated circuitry and the like. The communication interface may be wired or may be wireless. Software and data transferred via the communication interface may include, but not limited to, payment card data that is temporarily stored in the volatile memory module 104, a retrieved BIN range, a retrieved BIN, and software updates.

Uploading the payment card data that is temporarily stored in the volatile memory module 104, the retrieved issuer identity, or the retrieved payment network (i.e. card brand) to an external computing device may be useful when law enforcement personnel recover a larger number of suspected fraudulent payment cards. User authentication is preferably performed before such data can be uploaded to the external computing device. The data may be exported onto a spreadsheet. In such an implementation, the event may comprise exporting/uploading data to an external computing device. That is, after the obtained data and/or retrieved data is exported/uploaded to an external computing device, the data stored in the volatile memory module 104 is erased.

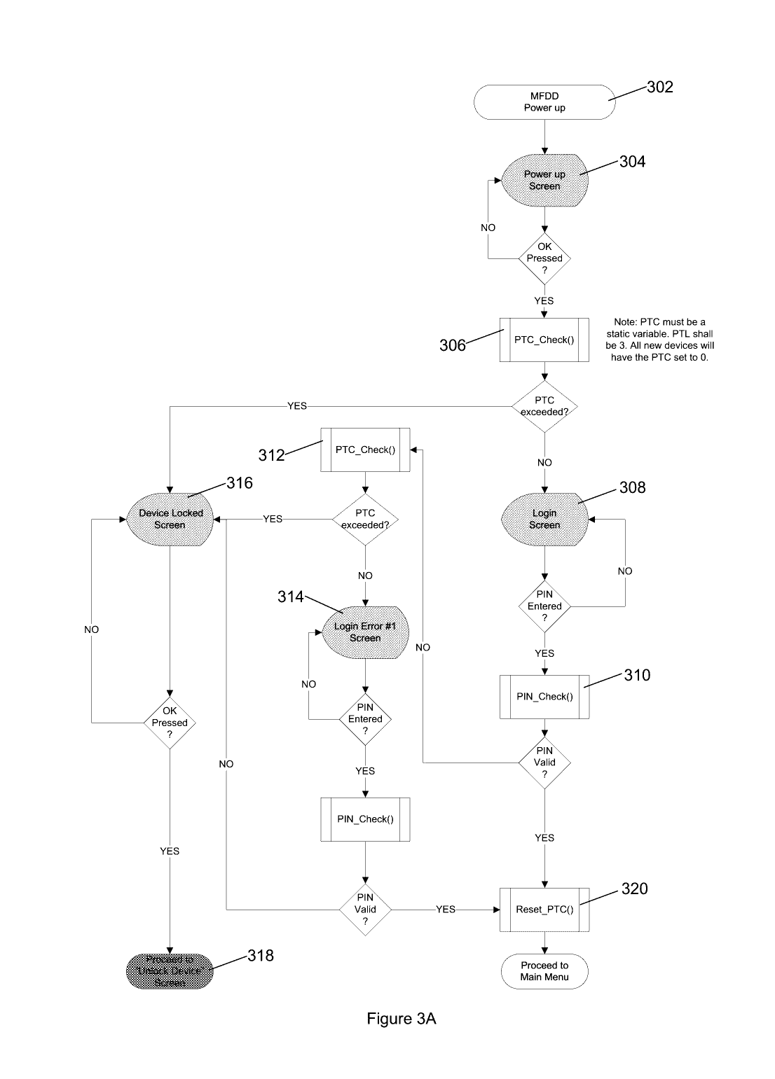

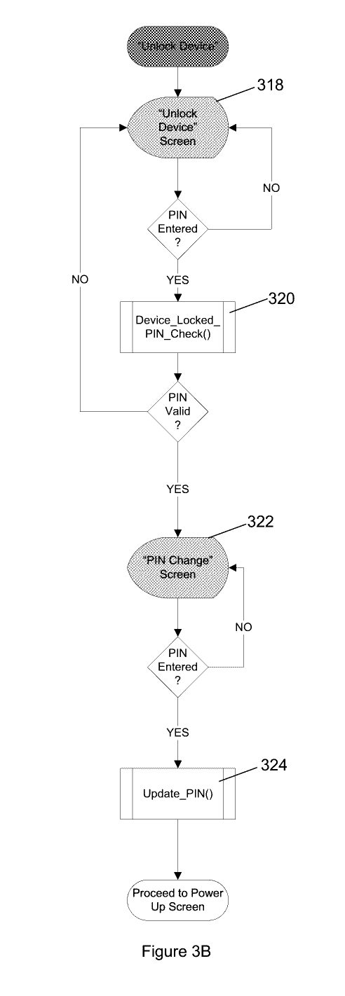

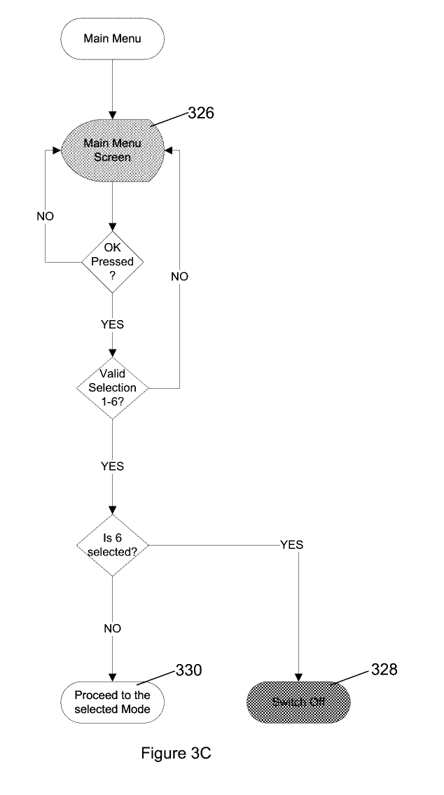

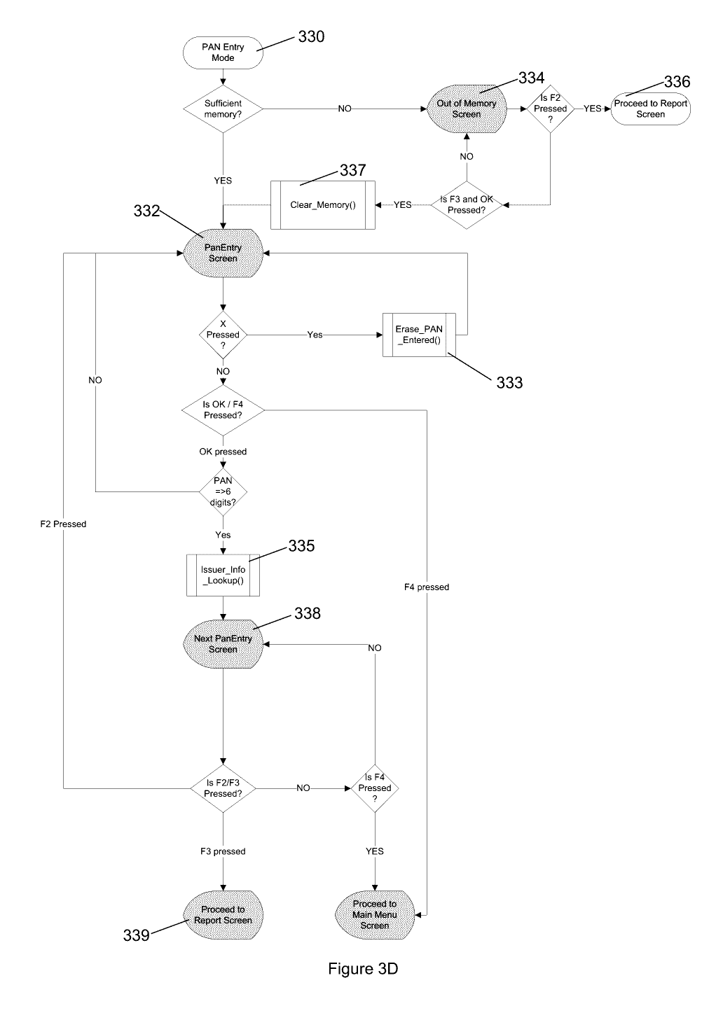

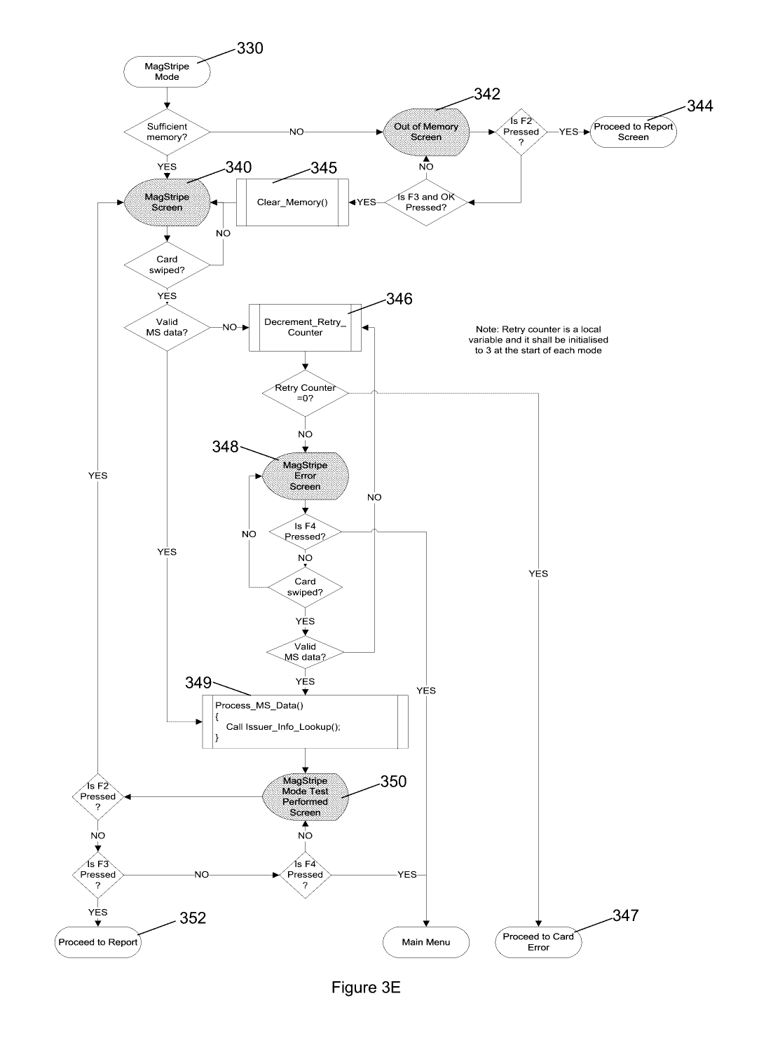

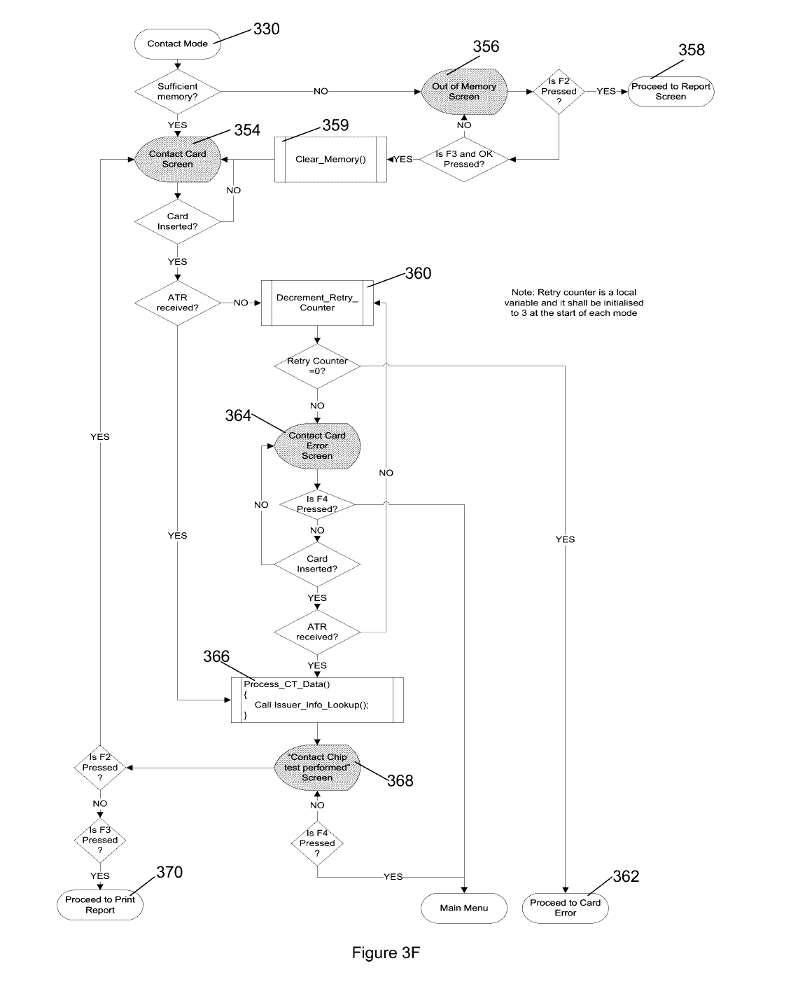

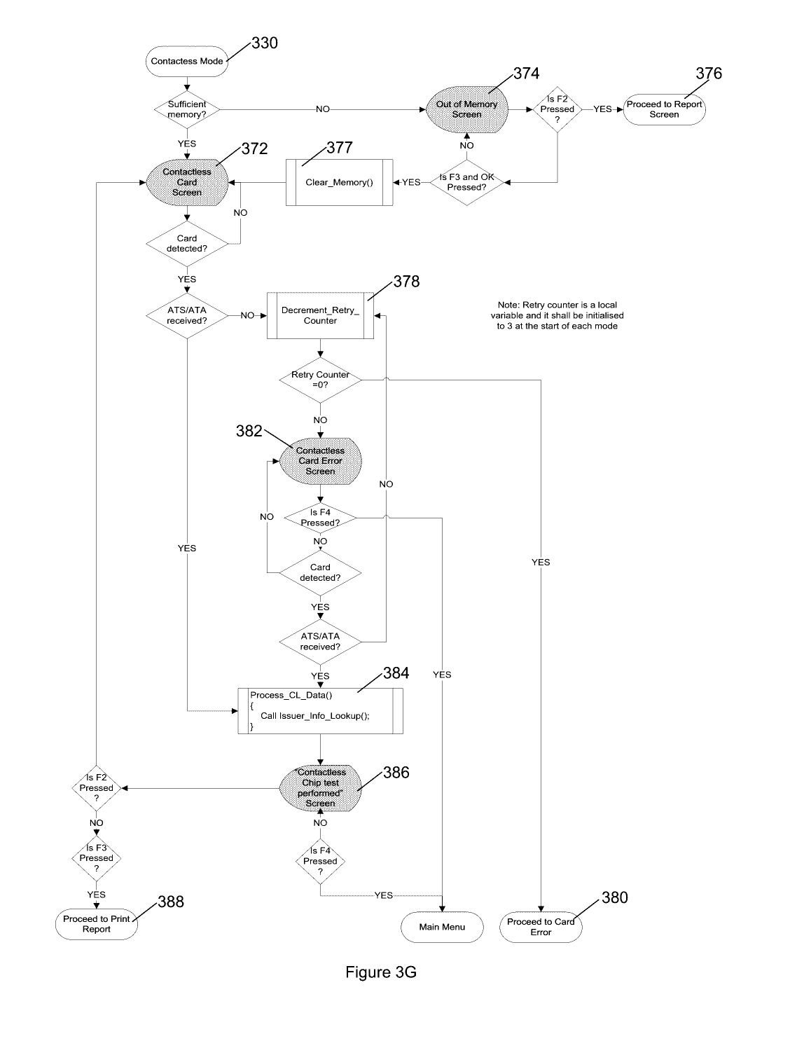

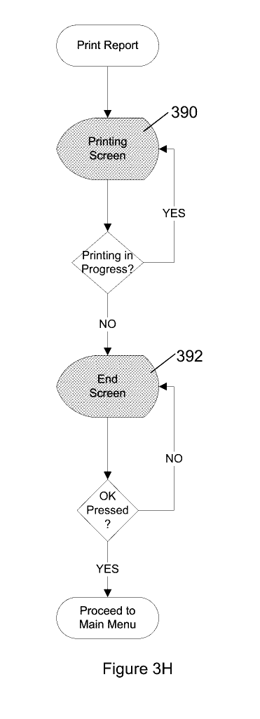

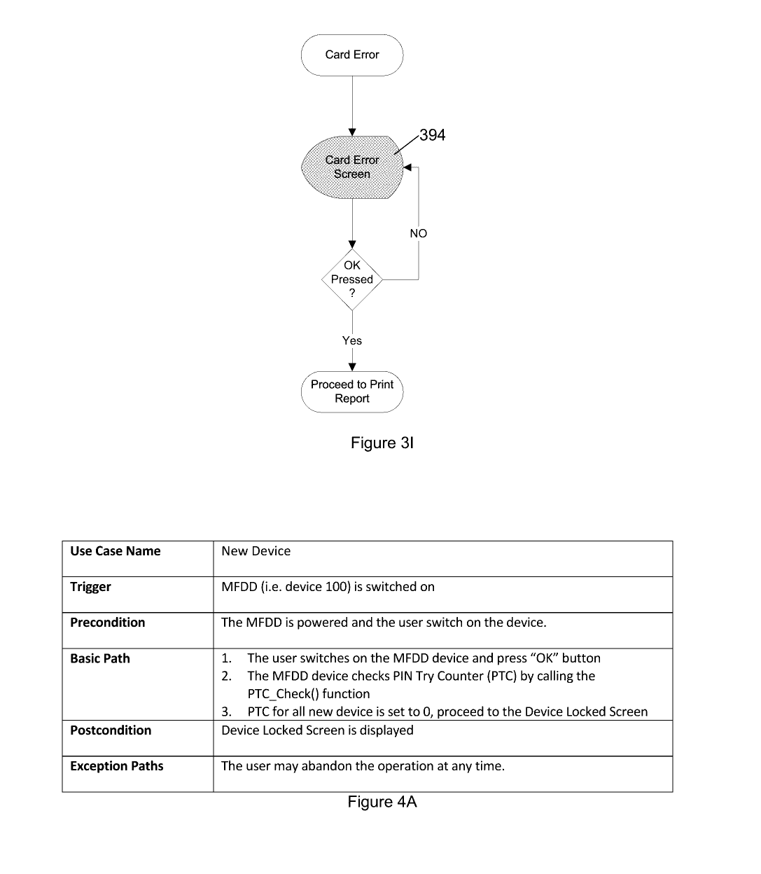

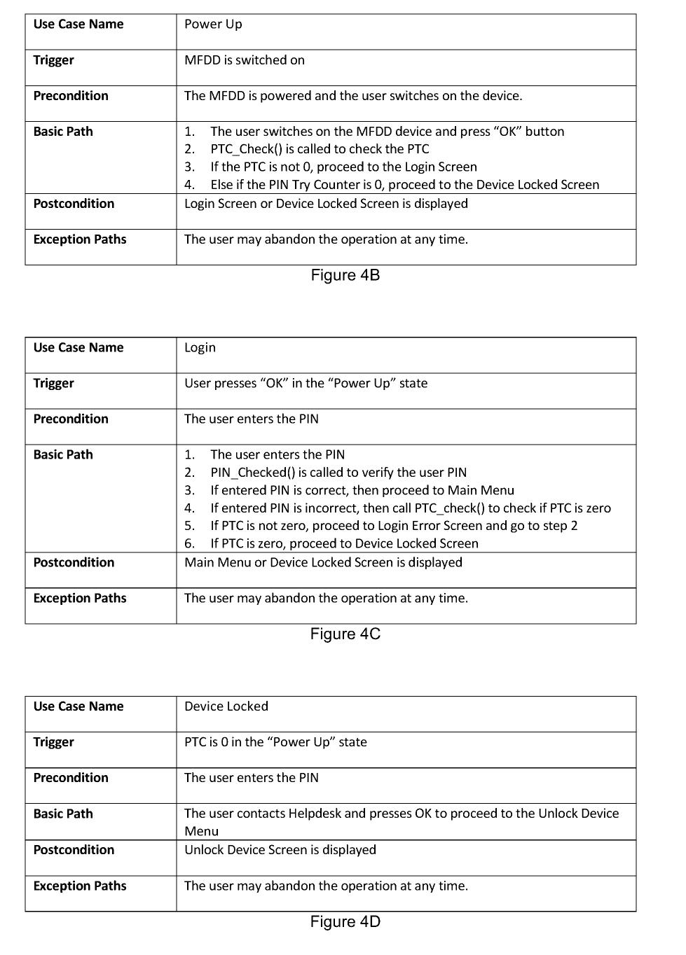

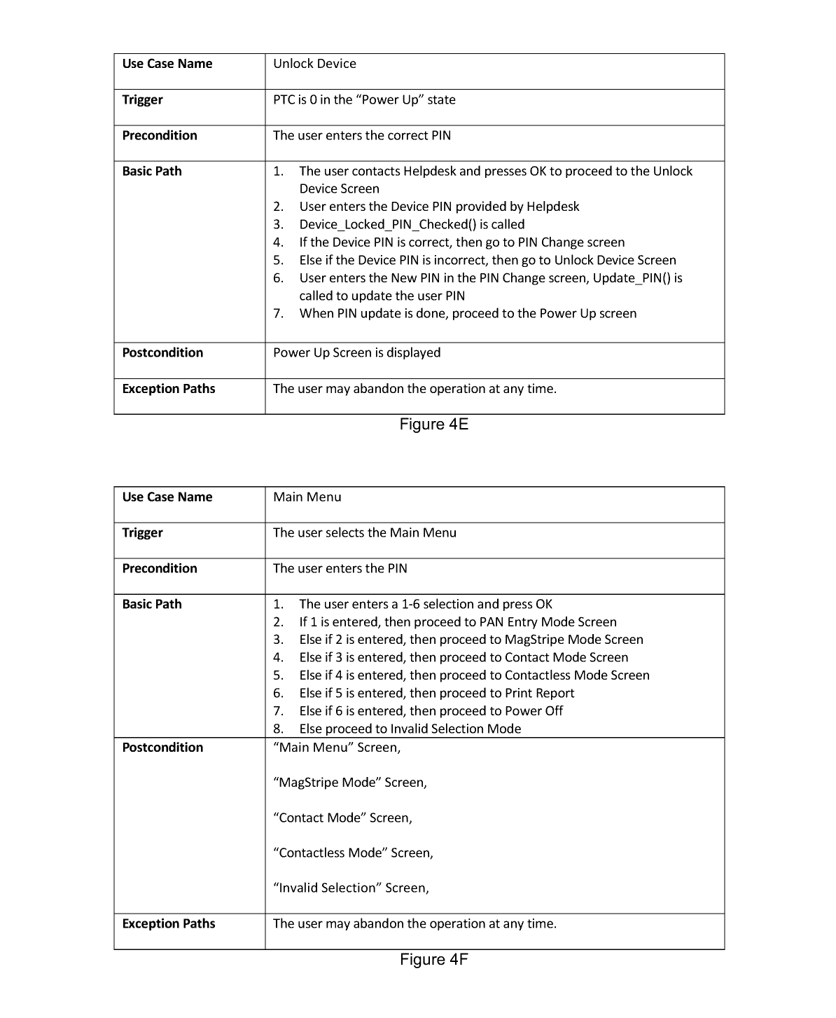

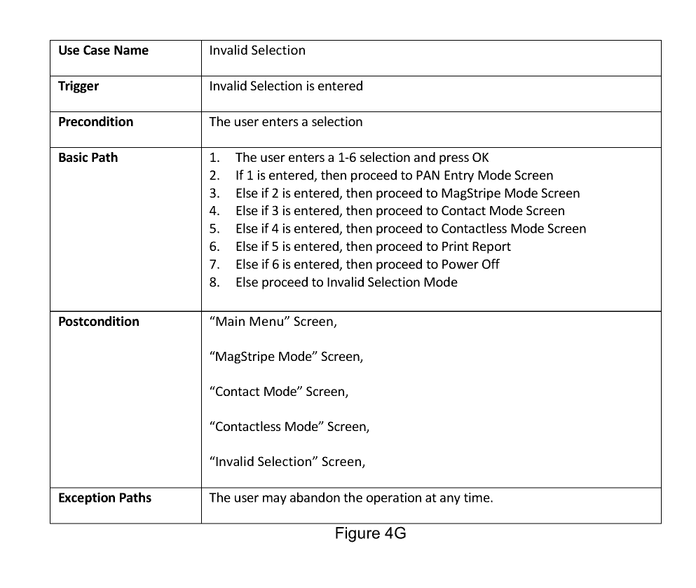

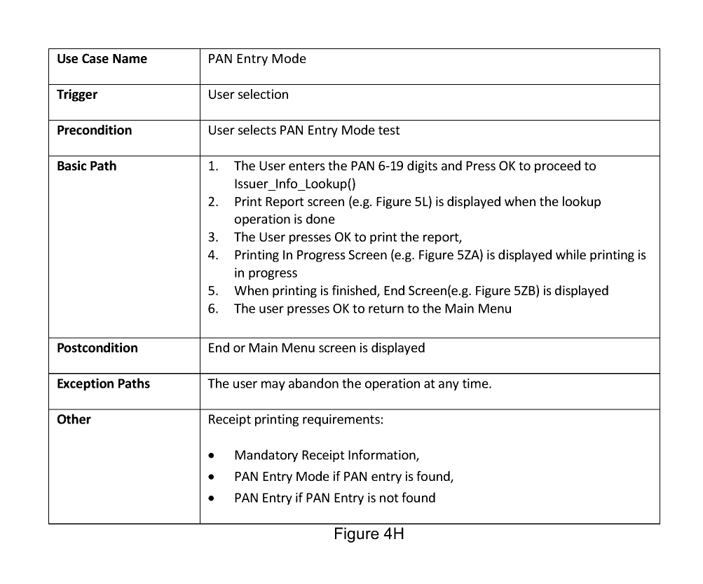

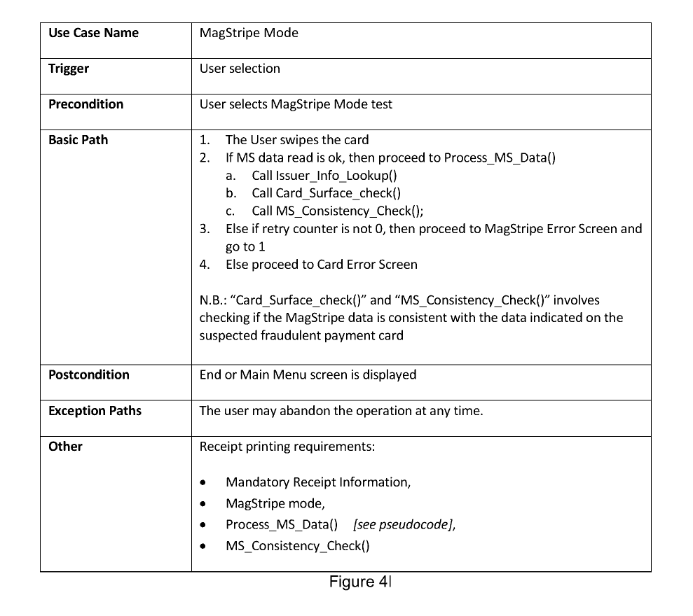

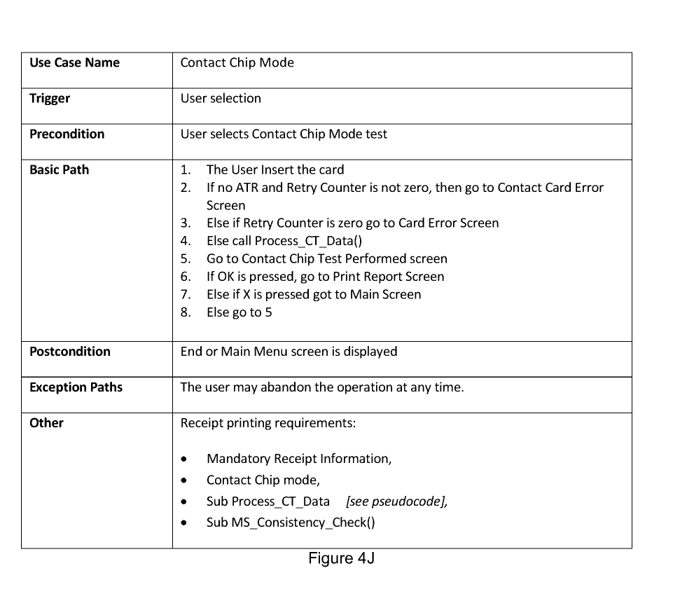

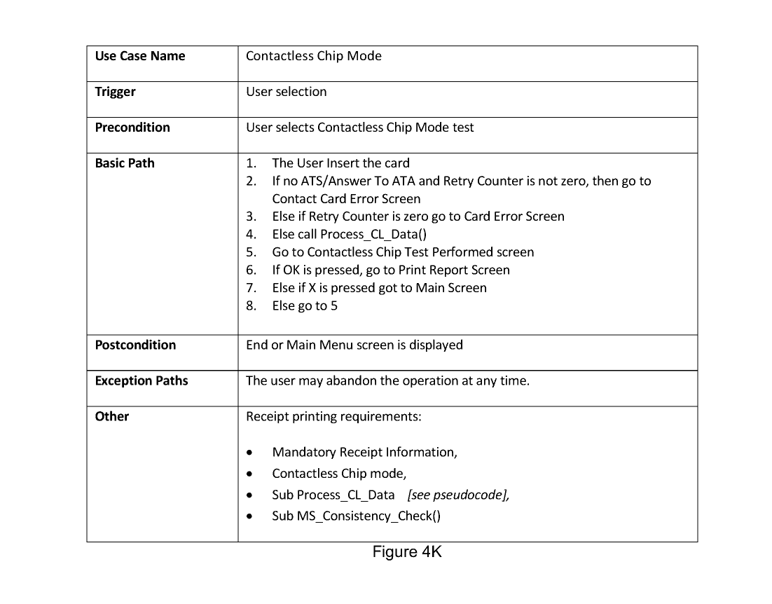

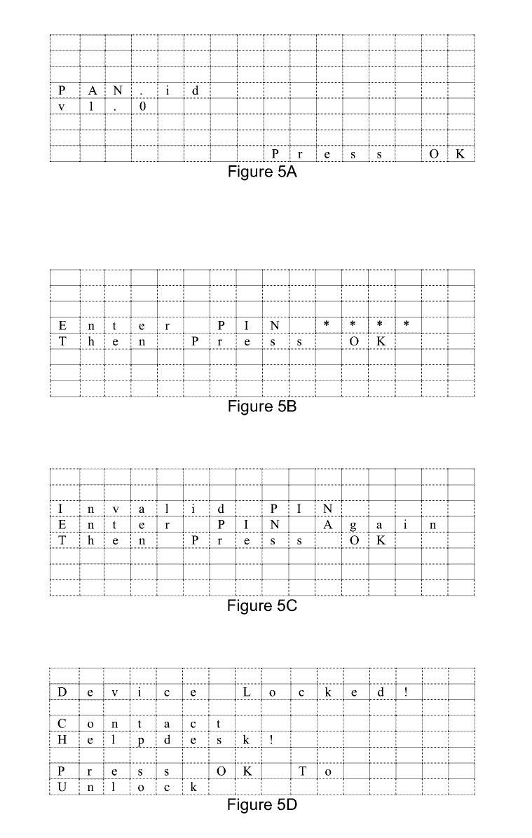

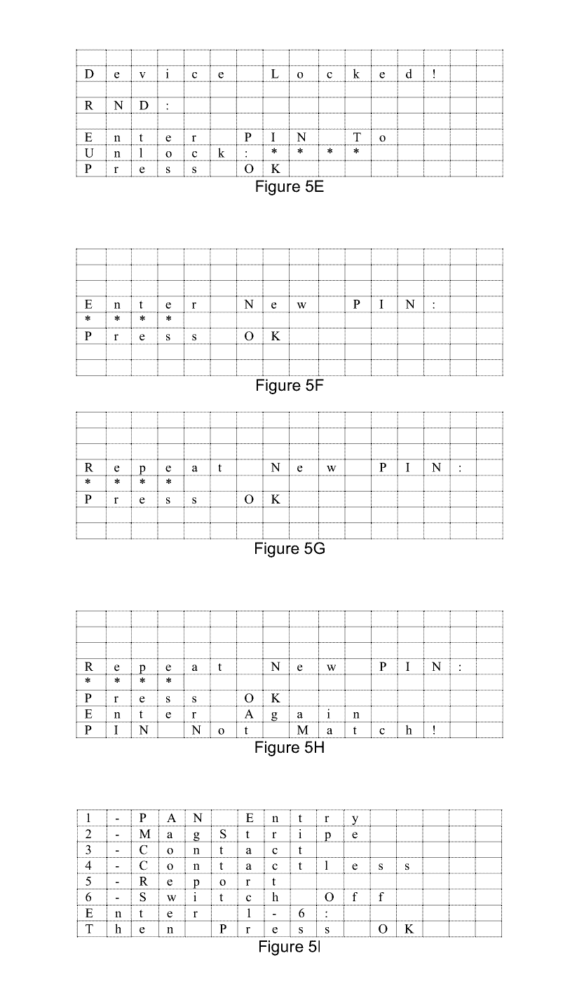

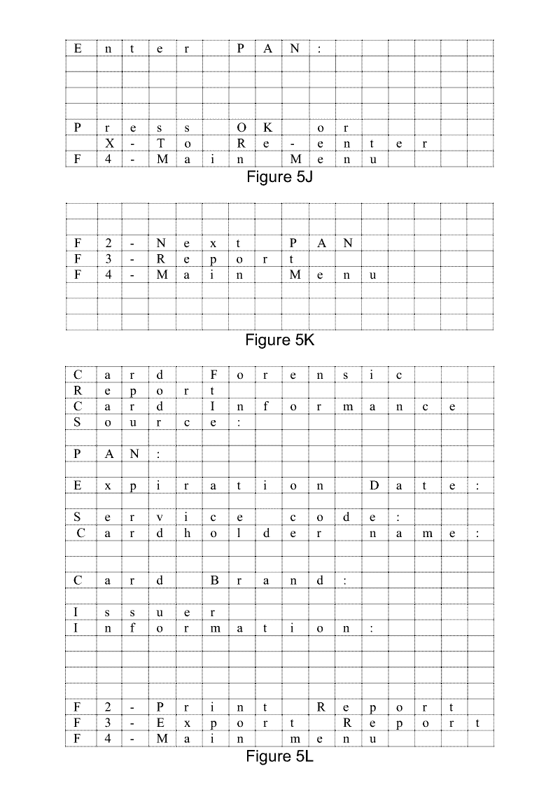

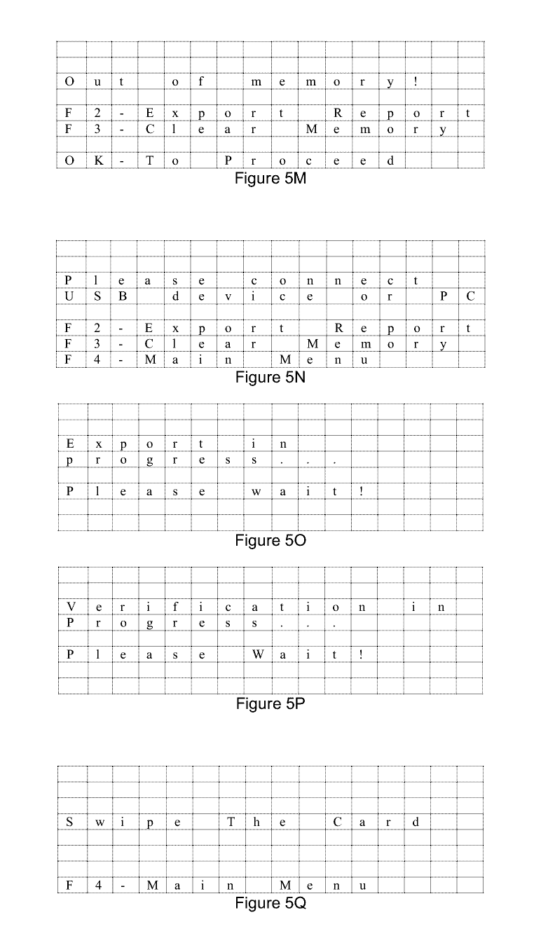

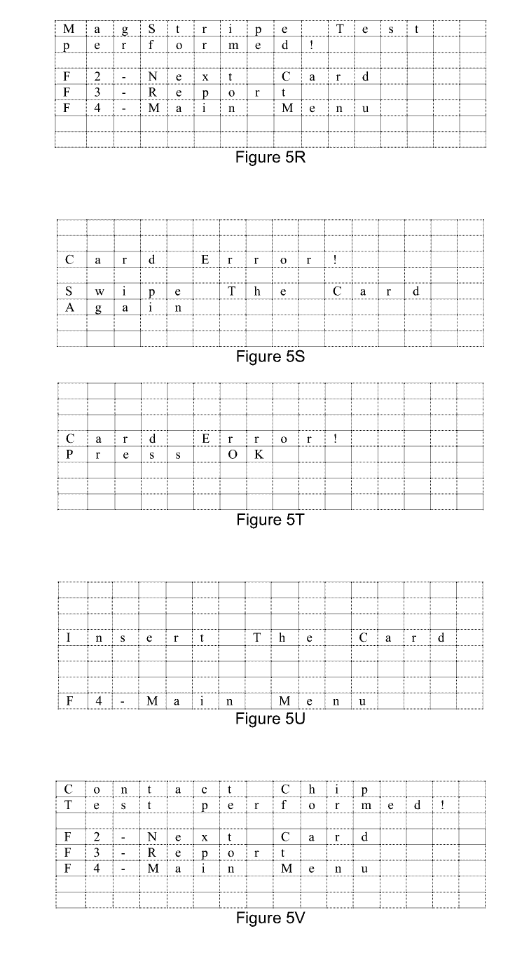

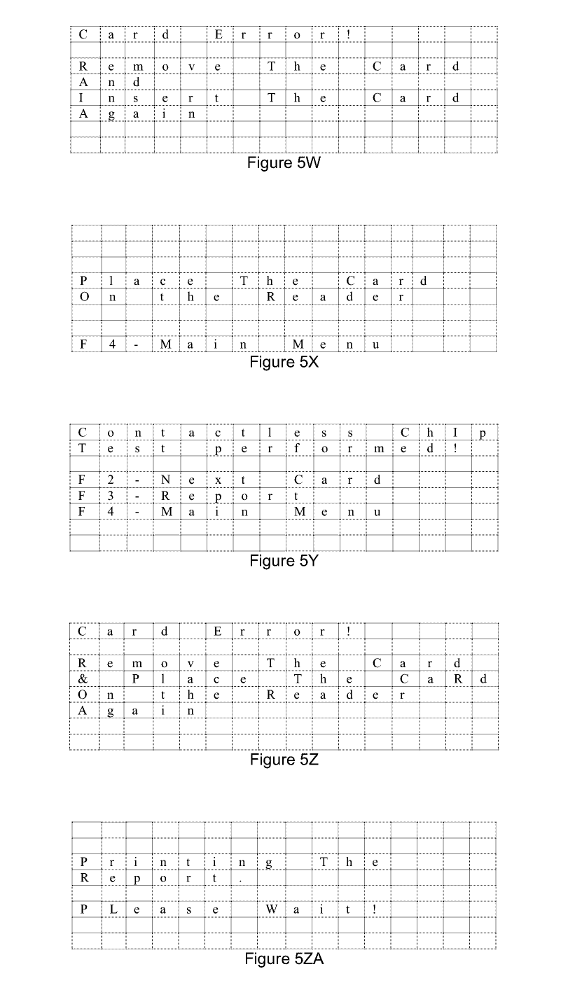

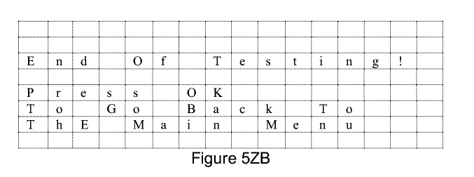

FIGS. 3A to 3I show flow charts illustrating exemplary process flows associated with operations/use cases according to various embodiments. FIGS. 4A to 4K specify functional requirements associated with the operations and FIGS. 5A to 5ZB show exemplary outputs on a display screen. The operations include: (i) power-up, (ii) device unlock, (iii) main menu, (iv) manual PAN entry mode, (v) MagStripe mode, (vi) Contact-card mode, (vii) Contactless-card mode, (viii) Report printing and (ix) card error.

FIG. 3A shows a flow chart illustrating an exemplary process flow associated with power-up of the device 100. FIG. 4A specifies the functional requirements associated with power-up of a new device 100 while FIG. 4B specifies the functional requirements associated with a subsequent power-up of the device 100. With reference to FIG. 3A, the device 100 is switched on at step 302 and a power-up screen is displayed at step 304. FIG. 5A shows an exemplary screen display when the device 100 is turned on. If the user presses the “OK” button on the keypad of the device 100, the device 100 checks a PIN Try Counter (PTC) by calling a PTC-Check function at step 306. The PTC is a static variable that can be set at any value (e.g. “0” for a new device, “3” subsequently). If the value of the PTC is not exceeded, a login screen is displayed (e.g. as shown in FIG. 5B) at step 308, requesting the user to input the PIN. The PIN is checked at step 310. FIG. 4C specifies the functional requirements associated with login of the device 100.

If an invalid PIN is entered, the value of the PTC is increased by one count and the PTC is checked at step 312. If the value of the PTC is not exceeded, the user is notified and asked to re-enter the PIN (e.g. as shown in FIG. 5C) at step 314.

If the value of the PTC is exceeded, a device-locked screen is displayed (e.g. as shown in FIG. 5D) at step 316. The user may contact a helpdesk/administrator to issue an unlock PIN. If the user presses “OK”, an unlock-device screen is displayed (e.g. as shown in FIG. 5E) at step 318. FIG. 4D specifies the functional requirements associated with locking of the device 100.

If it is determined (at step 310) that a valid PIN is entered, the PTC is reset at step 320 and a main menu screen is displayed (e.g. as shown in FIG. 5I).

Continuing from step 318 but now turning to FIG. 3B, which relates to an unlock-device operation, the user enters the unlock PIN. At step 320, the unlock PIN is checked. If the unlock PIN is invalid, the unlock-device screen (e.g. FIG. 5E) is displayed again. If the unlock PIN is valid, the PIN change screen is displayed (e.g. as shown in FIG. 5F) at step 322. The user may set his new PIN (i.e. different from the unlock PIN). The user may be asked to re-enter the new PIN (e.g. as shown in FIG. 5G). The new PIN is updated at step 324 if the re-entered PIN matches the initially entered PIN. Otherwise, the user is notified (e.g. as shown in FIG. 5H). FIG. 4E specifies the functional requirements associated with unlocking of the device 100.

FIG. 3C shows a flow chart illustrating an exemplary process flow associated with a main menu display operation of the device 100. FIG. 4F specifies the functional requirements associated with the main menu display operation. At step 326, the main menu screen is displayed (e.g. as shown in FIG. 5I). The user has a few options to choose from, such as manual PAN entry, MagStripe mode, Contact card mode, Contactless card mode, report printing or switching the device off. The user makes his selection and presses “OK”.

If the selection is valid, and “6” is pressed (i.e. to switch the device off), the device 100 is powered down at step 328. If the selection is valid and “1”, “2”, “3”, “4” or “5” is pressed, the respective mode is initiated at step 330.

If the selection is invalid (i.e. neither “1”, “2”, “3”, “4”, “5”, or “6” is pressed), the invalid selection operation is initiated and the device continues to display the menu screen (FIG. 5I). FIG. 4G specifies the functional requirements associated with entry of an invalid selection.

Continuing from step 330, if “1” is entered, the manual PAN entry mode is initiated. FIG. 3D shows a flow chart illustrating an exemplary process flow associated with a manual PAN entry mode. FIG. 4H specifies the functional requirements associated with the manual PAN entry mode. Firstly, a check is performed to determine if there is sufficient memory. If there is sufficient memory, a PAN entry screen is displayed (e.g. as shown in FIG. 5J) at step 332. If there is insufficient memory, an out-of-memory screen is displayed (e.g. as shown in FIG. 5M) at step 334. The user can press “F2” to proceed to view a card forensic report (e.g. as shown in FIG. 5L) related to the previous payment card which is generated at step 336. The user can press “F3” to clear the memory at step 337.

Continuing from step 332, the user enters the PAN. The user can press “X” if he makes a mistake to erase the entered PAN and can re-enter the PAN, as per step 333. After the user enters the PAN and presses “OK”, a check is performed to determine if the PAN contains six or more digits (which is traditionally the case). If not, the PAN entry screen (FIG. 5J) is displayed. If the PAN contains six or more digits, an issuer information lookup process is initiated at step 335.

As mentioned above, a plurality of Bank Identification Numbers (BINs) and an issuer identity corresponding to each BIN is stored in a non-volatile memory module. The issuer information lookup process involves determining the BIN based on the manually entered PAN, and retrieving/looking-up the issuer identity corresponding to the determined BIN.

After entering a first PAN, the user can choose whether or not to enter another PAN. A next PAN-entry screen is displayed (e.g. as shown in FIG. 5K) at step 338. If the user presses “F2”, the PAN entry screen is displayed again (e.g. as shown in FIG. 5J). The retrieved issuer identity corresponding to the first PAN may be actively or passively erased from the relevant memory for security reasons. The user can also press “F3” to generate a card forensic report (step 339) or “F4” to return to the main menu.

Continuing from step 330, if “2” is entered, the MagStripe mode is initiated. FIG. 3E shows a flow chart illustrating an exemplary process flow associated with a MagStripe mode. FIG. 4I specifies the functional requirements associated with the MagStripe mode. Firstly, a check is performed to determine if there is sufficient memory. If there is sufficient memory, a MagStripe screen is displayed (e.g. as shown in FIG. 5Q) at step 340. If there is insufficient memory, an out-of-memory screen is displayed (e.g. as shown in FIG. 5M) at step 342. The user can press “F2” to proceed to view a card forensic report (e.g. as shown in FIG. 5L) related to the previous payment card which is generated at step 344. Alternatively, the user can press “F3” to clear the memory at step 345.

Continuing from step 340, the user swipes the suspected fraudulent payment card 110 at the magnetic stripe reader of the device 100. The magnetic stripe reader reads the data that is encoded on the magnetic stripe. A check is performed to determine if the read data is valid.

If the read data is not valid, a value of a Retry Counter is decreased at step 346. The value of the Retry Counter is a local variable and may be set at “3” at the start of each mode. If the value of the Retry Counter is “0”, a card error operation is initiated at step 347. If the value of the Retry Counter is not “0”, a MagStripe Error screen is displayed (e.g. as shown in FIG. 5S) at step 348. The user can try swiping the payment card 110 again. If the user presses “F4”, the current MagStripe mode is exited and the main menu is displayed.

If the read data is valid, the data is processed at step 349. The pseudocode related to the processing of MagStripe data (“Process_MS_Data( )”) is provided below. In particular, the data encoded on Track 1 of the magnetic stripe (PAN, expiration date, service code and cardholder name) and Track 2 of the magnetic stripe (PAN, expiration date and service code) is obtained. The obtained data can be displayed on the screen of the device 100 and optionally printed out on a medium. The issuer identity and/or payment network (card brand) may be retrieved/determined based on the obtained data (e.g. the obtained PAN) and also optionally printed out. Thereafter, at step 350, a MagStripe Mode Test Performed screen is displayed (e.g. as shown in FIG. 5R). If the user presses “F2”, a next suspected fraudulent payment card may be swiped (see step 340). If user presses “F3”, a card forensic report related to the current payment card is generated and displayed (e.g. as shown in FIG. 5L) at step 352. If user presses “F4”, the current MagStripe mode is exited and the main menu is displayed. The data stored in the relevant memory may be actively erased when the uses presses any one of “F2”, “F3” or “F4”.

Continuing from step 330, if “3” is entered, the Contact chip (card) mode is initiated. FIG. 3F shows a flow chart illustrating an exemplary process flow associated with a Contact chip mode. FIG. 4J specifies the functional requirements associated with the Contact chip mode. Firstly, a check is performed to determine if there is sufficient memory. If there is sufficient memory, a Contact Card screen is displayed (e.g. as shown in FIG. 5U) at step 354. If there is insufficient memory, an out-of-memory screen is displayed (e.g. as shown in FIG. 5M) at step 356. The user can press “F2” to proceed to view a card forensic report (e.g. as shown in FIG. 5L) related to the previous payment card which is generated at step 358. Alternatively, the user can press “F3” to clear the memory at step 359.

Continuing from step 354, the user inserts/dips the suspected fraudulent payment card 110 into the IC reader of the device 100. The IC reader reads the data that is encoded on the IC (chip). A check is performed to determine if an “Answer to Reset” (ATR) message is received. The ATR message conveys information about the communication parameters proposed by the payment card, and the payment card's nature and state.

If the ATR message is not received, a value of a Retry Counter is decreased at step 360. The value of the Retry Counter is a local variable and may be set at “3” at the start of each mode. If the value of the Retry Counter is “0”, a card error operation is initiated at step 362. If the value of the Retry Counter is not “0”, a Contact Card Error screen is displayed (e.g. as shown in FIG. 5W) at step 364. The user can try inserting the payment card 110 again. If the user presses “F4”, the current Contact chip mode is exited and the main menu is displayed.

If the ATR message is received, the data is processed at step 366. The pseudocode related to the processing of Contact chip data (“Process_CT_Data( )”) is provided below. In particular, the encoded data corresponding to the relevant data fields/EMV tags (e.g. PAN, expiration date, service code and cardholder name) is obtained. The obtained data can be displayed on the screen of the device 100 and optionally printed out on a medium. The issuer identity and/or payment network (card brand) may be retrieved/determined based on the obtained data (e.g. the obtained PAN) and also optionally printed out. Thereafter, at step 368, a Contact Chip Test Performed screen is displayed (e.g. as shown in FIG. 5V). If the user presses “F2”, a next suspected fraudulent payment card may be inserted into the IC reader (see step 354). If user presses “F3”, a card forensic report related to the current payment card is generated and displayed (e.g. as shown in FIG. 5L) at step 370. If user presses “F4”, the current Contact chip mode is exited and the main menu is displayed. The data stored in the relevant memory may be actively erased when the uses presses any one of “F2”, “F3” or “F4”.

Continuing from step 330, if “4” is entered, the Contactless chip (card) mode is initiated. FIG. 3G shows a flow chart illustrating an exemplary process flow associated with a Contactless chip mode. FIG. 4K specifies the functional requirements associated with the Contactless chip mode. Firstly, a check is performed to determine if there is sufficient memory. If there is sufficient memory, a Contactless Card screen is displayed (e.g. as shown in FIG. 5X) at step 372. If there is insufficient memory, an out-of-memory screen is displayed (e.g. as shown in FIG. 5M) at step 374. The user can press “F2” to proceed to view a card forensic report (e.g. as shown in FIG. 5L) related to the previous payment card which is generated at step 376. Alternatively, the user can press “F3” to clear the memory at step 377.

Continuing from step 372, the user taps/places the suspected fraudulent payment card 110 on/near the contactless IC reader of the device 100 (e.g. NFC, RFID reader). The contactless IC reader reads the data that is encoded on the contactless IC (chip). A check is performed to determine if an “Answer to Select/Answer to ATTRIB” (ATS/ATA) message is received.

If the ATS/ATA message is not received, a value of a Retry Counter is decreased at step 378. The value of the Retry Counter is a local variable and may be set at “3” at the start of each mode. If the value of the Retry Counter is “0”, a card error operation is initiated at step 380. If the value of the Retry Counter is not “0”, a Contactless Card Error screen is displayed (e.g. as shown in FIG. 5Z) at step 382. The user may try tapping the payment card 110 again. If the user presses “F4”, the current Contactless chip mode is exited and the main menu is displayed.

If the ATS/ATA message is received, the data is processed at step 384. The pseudocode related to the processing of Contactless chip data (“Process_CL_Data( )”) is provided below. In particular, the encoded data corresponding to the relevant data fields/EMV tags (e.g. PAN, expiration date, service code and cardholder name) is obtained. The obtained data can be displayed on the screen of the device 100 and optionally printed out on a medium. The issuer identity and/or payment network (card brand) may be retrieved/determined based on the obtained data (e.g. the obtained PAN) and also optionally printed out. Thereafter, at step 386, a Contactless Chip Test Performed screen is displayed (e.g. as shown in FIG. 5Y). If the user presses “F2”, a next suspected fraudulent payment card may be placed near the IC reader (see step 372). If user presses “F3”, a card forensic report related to the current payment card is generated and displayed (e.g. as shown in FIG. 5L) at step 388. In FIG. 5L, the “Card Information Source” field indicates whether the data source is manual PAN entry, MagStripe, Chip or Contactless. If user presses “F4”, the current Contact chip mode is exited and the main menu is displayed. The data stored in the relevant memory may be actively erased when the uses presses any one of “F2”, “F3” or “F4”.

FIG. 3H shows a flow chart illustrating an exemplary process flow associated with a Print Report operation. Continuing from steps 339, 352, 370 or 388, when “F3” is pressed, a card forensic report is printed out. FIG. 2 shows an exemplary printout. At step 390, when printing is in progress, the Printing screen is displayed (as shown in FIG. 5ZA). Once printing is completed, the End screen is displayed (as shown in FIG. 5ZB). The user can press “OK” to return to the main menu.

FIG. 3I shows a flow chart illustrating an exemplary process flow associated with a Card Error operation. Continuing from steps 347, 362 or 380, a Card Error screen is displayed (e.g. as shown in FIG. 5T) at step 394. If the user presses “OK”, the Print Report operation is initiated (see FIG. 3H).

With reference to FIGS. 5L and M, the user can also press “F3” to export the report. FIG. 5N shows an exemplary output on a display screen when an export operation is triggered. The user connects the device 100 to an external computing device via a USB cable. FIG. 5O shows an exemplary output on a display screen when an export operation is in progress. The export process may include a verification step to ensure that the exported data is correct. FIG. 5P shows an exemplary output on a display screen during the export verification process.

The pseudocode corresponding to some of the processes mentioned above is as follows:

Process_MS_Data( ):

```
Process_MS_Data( )
{
if Track 1 data is valid
  set fTrack1_Valid;
  set sTrack1_PAN to track1 data;
  set sTrack1_Expiration_Date to track1 data;
  set sTrack1_Service_Code to track1 data;
  set sTrack1_Card_Holder_Name to track1 data;
if Track 2 data is valid
  set fTrack2_Valid;
  set sTrack2_PAN to track2 data;
  set sTrack2_Expiration_Date to track2 data;
  set sTrack2_Service_Code to track2 data;
Call Issuer_Info_Lookup(sTrack1_PAN, MS_Card_Brand);
  print “PAN: sTrack1_PAN”;
  print“Card Brand: MS_Card_Brand”;
  print “Expiration Date: sTrack1_Expiration_Date”;
  print “Service code: sTrack1_Service_Code ”
  print “Cardholder Name: sTrack1_Cardholder_Name”
  print “Issuer Info: MasterCard_Member_Info”
return;
}
```

Process_CT_Data( )

```
Process_CT_Data( )
{
  Conduct an online CT Chip transaction;
  set Tag 5A to CT_PAN;
  set Tag 5F24 to CT_Expiration_Date;
  set Tag 5F20 to CT_Card_Holder_Name;
  set Tag 57 to CT_Service_Code;
  Call Issuer_Info_Lookup(CT_PAN, CT_Brand);
  print “PAN: sTrack1_PAN”;
  print“Card Brand: MS_Card_Brand”;
  print “Expiration Date: CT_Expiration_Date ”;
  print “Service code: CT_Service_Code ”
  print “Cardholder Name: CT_Card_Holder_Name ”
  print “Issuer Info: MasterCard_Member_Info”
  return;
}
```

Process_CL_Data( )

```
Process_CL_Data( )
{
  Conduct an online CL Chip transaction;
  set Tag 5A to CL_PAN;
  set Tag 5F24 to CL_Expiration_Date;
  set Tag 5F20 to CL_Card_Holder_Name;
  set Tag 57 to CL_Service_Code;
  Call Issuer_Info_Lookup(CL_PAN, CL_Brand);
  print “PAN: sTrack1_PAN”;
  print“Card Brand: MS_Card_Brand”;
  print “Expiration Date: CT_Expiration_Date ”;
  print “Service code: CL_Service_Code ”
  print “Cardholder Name: CT_Card_Holder_Name ”
  print “Issuer Info: MasterCard_Member_Info”
  return;
}
```

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A device for facilitating identification of a fraudulent payment card, comprising:
an input module for obtaining data encoded on a suspected fraudulent payment card;
a volatile memory module for temporary storage of the obtained data; and
a display module for rendering the obtained data on a display screen, wherein the obtained data that is stored in the volatile memory module is cleared after completion of an event.

2. The device as claimed in claim 1, wherein the event comprises obtaining, by the input module, data encoded on a subsequent suspected fraudulent payment card.

3. The device as claimed in claim 1, wherein the event comprises obtaining, by the input module, data encoded on a pre-determined quantity of suspected fraudulent payment cards.

4. The device as claimed in claim 1, wherein the event comprises expiry of a pre-determined period of time.

5. The device as claimed in claim 1, wherein the data comprises at least one of: primary account number (PAN), expiration date, service code, and cardholder name.

6. The device as claimed in claim 1, further comprising an authentication module for authenticating a user of the device based on credentials received by the authentication module to allow usage of the device.

7. The device as claimed in claim 1, further comprising:
a processor module; and
a non-volatile memory module for persistent storage of a plurality of Bank Identification Number (BIN) ranges and a payment network corresponding to each range,
wherein the processor module is configured to: (i) determine the BIN range based on the obtained data, and (ii) retrieve the payment network corresponding to the determined BIN range.

8. The device as claimed in claim 7, wherein the display module is further configured for rendering the retrieved payment network on the display screen.

9. The device as claimed in claim 1, further comprising:
a processor module; and
a non-volatile memory module for persistent storage of a plurality of Bank Identification Numbers (BINs) and an issuer identity corresponding to each BIN,
wherein the processor module is configured to: (i) determine the BIN based on the obtained data, and (ii) retrieve the issuer identity corresponding to the determined BIN.

10. The device as claimed in claim 9, wherein the display module is further configured for rendering the retrieved issuer identity on the display screen.

11. The device as claimed in claim 1, further comprising:
a processor module; and
a non-volatile memory module for persistent storage of a plurality of Bank Identification Numbers (BINs) and an issuer identity corresponding to each BIN,
wherein the input module is configured for receiving a primary account number (PAN) provided by a user, and
wherein the processor module is configured to: (i) determine the BIN based on the obtained PAN, and (ii) retrieve the issuer identity corresponding to the determined BIN.

12. The device as claimed in claim 1, wherein the input module comprises a magnetic stripe reader for obtaining data encoded on a magnetic stripe on the suspected fraudulent payment card.

13. The device as claimed in claim 1, wherein the input module comprises an integrated circuit (IC) reader for obtaining data encoded on an IC on the suspected fraudulent payment card.

14. The device as claimed in claim 1, wherein the input module comprises a Near Field Communication (NFC) reader for obtaining data encoded on a NFC tag on the suspected fraudulent payment card.

15. The device as claimed in claim 1, wherein the input module comprises a Radio-frequency Identification (RFID) reader for obtaining data encoded on a RFID tag on the suspected fraudulent payment card.

16. The device as claimed in claim 1, further comprising a printer for printing the obtained data on a medium.

17. The device as claimed in claim 16, wherein the event comprises printing of the obtained data on the medium.
